(19) United States
(12) Patent Application Publication
(10) Pub. No.: US 2023/0225370 A1
(43) Pub. Date: Jul. 20, 2023

(54) VACUUM FRESH-KEEPING FEEDER WITH REPLACEABLE FOOD BUCKET

(71) Applicant: YIZHUO YU, SHENZHEN CITY (CN)

(72) Inventor: YIZHUO YU, SHENZHEN CITY (CN)

(21) Appl. No.: 17/673,058

(22) Filed: Feb. 16, 2022

(30) Foreign Application Priority Data
Jan. 17, 2022 (CN) 202220116512.4

(51) Int. Cl. A23K 30/00; A01K 5/02

(52) U.S. Cl. CPC A23K 30/00; A01K 5/0225

(57) ABSTRACT

The present invention provides a vacuum fresh-keeping feeder with a replaceable food bucket, relating to the technical field of pet feeders. The vacuum fresh-keeping feeder includes: an accommodating bucket; a discharge assembly, where the discharge assembly is connected to the accommodating bucket, and when the discharge assembly stops working, the accommodating bucket is kept in a sealed state; and a vacuum apparatus, where the vacuum apparatus is disposed on the accommodating bucket, and the vacuum apparatus is configured to draw air in the accommodating bucket. A connector is disposed between the discharge assembly and the accommodating bucket. According to the foregoing technical solution, the vacuum fresh-keeping feeder with a replaceable food bucket has the advantage that pet food in the feeder can be stored for a longer time by vacuum treatment.

### FIELD OF THE DISCLOSURE

The present invention relates to the technical field of pet feeders, and in particular, to a vacuum fresh-keeping feeder with a replaceable food bucket.

### BACKGROUND OF THE DISCLOSURE

With the continuous improvement of residents' living standards, a growing number of domestic urban residents keep pets. Pets have become indispensable good companions for many old people, children and even workers, and also become people's spiritual ballast to relax. However, in real life, since no special person takes care of or feeds pets in most of families, pet owners' going out early and coming home late makes pets have to eat in a hurry only in the morning and in the evening but have nothing to eat when they are hungry at home. It is convenient to buy pets, but raising pets is not an easy task. Especially when people go out for business or tourism, they usually cannot take timely and good care of pets at home, so feeding pets has become an outstanding problem that puzzles people. Therefore, automatic pet feeders have emerged.

Existing pet feeders can only keep the pet food fresh by using a desiccant or a seal ring in use. No effective solutions have been put forward yet by far against the problem of how to implement vacuumizing and dehumidifying and freshness keeping of the pet feeders in related technologies.

### SUMMARY OF THE DISCLOSURE

In view of the defects and deficiencies in the prior art, an objective of the present invention is to provide a vacuum fresh-keeping feeder with a replaceable food bucket, which has the advantage that pet food in the feeder is kept fresh by vacuum treatment, so that the pet food can be stored for a longer time.

To implement the foregoing objective, the technical solutions of the present invention is as follows: A vacuum fresh-keeping feeder with a replaceable food bucket includes: an accommodating bucket; a discharge assembly, where the discharge assembly is connected to the accommodating bucket, and when the discharge assembly stops working, the accommodating bucket is kept in a sealed state; and a vacuum apparatus, where the vacuum apparatus is disposed on the accommodating bucket, and the vacuum apparatus is configured to draw air in the accommodating bucket.

A connector is disposed between the discharge assembly and the accommodating bucket.

The connector includes: a clamping ring, where the clamping ring is provided with a plurality of clamping blocks; a first clamping part, where the first clamping part is disposed on a side of the discharge assembly close to the clamping ring, and the first clamping part and the clamping blocks are detachably assembled; and a second clamping part, where the second clamping part is disposed on the accommodating bucket and detachably assembled with the clamping blocks on the other side of the clamping ring.

The vacuum apparatus is a dry vacuum pump.

The discharge assembly includes: a food guide base, where the food guide base is disposed at the bottom of the accommodating bucket; and a discharge member, where the discharge member is disposed in the food guide base, a discharge frame communicating with the accommodating bucket is disposed on the discharge member, and the discharge member is configured to control food in the accommodating bucket to fall or stop falling.

The discharge member includes: a partition plate, where the partition plate is fixedly disposed in the food guide base, a second food leaking hole and a through-hole are provided in the partition plate; a motor fixedly disposed at the bottom of the partition plate, where an output shaft of the motor penetrates through the through-hole; and a rotation plate, where one side of the rotation plate is fixedly disposed at an end of the discharge frame away from the accommodating bucket, the other side of the rotation plate is closely attached to the partition plate, the rotation plate is connected to the output shaft of the motor, a first food leaking hole that corresponds to the second food leaking hole is provided in the rotation plate, an annular groove is provided in an outer edge of the partition plate, the rotation plate is rotationally disposed in the annular groove, and a diameter of the rotation plate is greater than or equal to a diameter of the discharge frame and less than a diameter of the annular groove.

The output shaft of the motor and the rotation plate are detachably assembled.

An upper cover is disposed on the accommodating bucket.

A seal ring is disposed at a joint of the upper cover and the accommodating bucket.

A food dish is disposed at the bottom of the discharge assembly.

After the foregoing technical solution is applied, the present invention has the beneficial effects as follows.

1. The discharge assembly is connected to the accommodating bucket. When the discharge assembly stops working, the accommodating bucket is kept in a sealed state. The vacuum apparatus is disposed on the accommodating bucket, and the vacuum apparatus is configured to draw air in the accommodating bucket. With such an arrangement, the vacuum fresh-keeping feeder with a replaceable food bucket effectively resolves the defects that an existing pet feeder can only keep the pet food fresh by using a desiccant or a seal ring in use, so that a fresh-keeping effect is poor, and it is troublesome to keep freshness. The vacuum fresh-keeping feeder with a replaceable food bucket has the advantage that pet food in the feeder is kept fresh by vacuum treatment, so that the pet food can be stored for a longer time.

2. The discharge assembly and the accommodating bucket are clamped, so that the accommodating bucket can be detached to facilitate cleaning or replacement. When this apparatus is not used for a long time, the accommodating bucket can be detached and cleaned, and the accommodating bucket can serve as a food storage bucket to store the pet food after being detached, to implement multiple functions.

### BRIEF DESCRIPTION OF THE DRAWINGS

To illustrate the technical solutions in the embodiments of the present invention or in the prior art more clearly, the following briefly describes the accompanying drawings required for describing the embodiments or the prior art. Apparently, the accompanying drawings in the following description show merely some embodiments of the present invention, and a person of ordinary skill in the art may still derive other accompanying drawings from these accompanying drawings without creative efforts.

FIG. 1 is a schematic structural diagram according to the present invention;

FIG. 2 is an exploded view that corresponds to FIG. 1;

FIG. 3 is a schematic structural diagram of a discharge assembly according to the present invention; and

FIG. 4 is a schematic structural diagram of a discharge member according to the present invention.

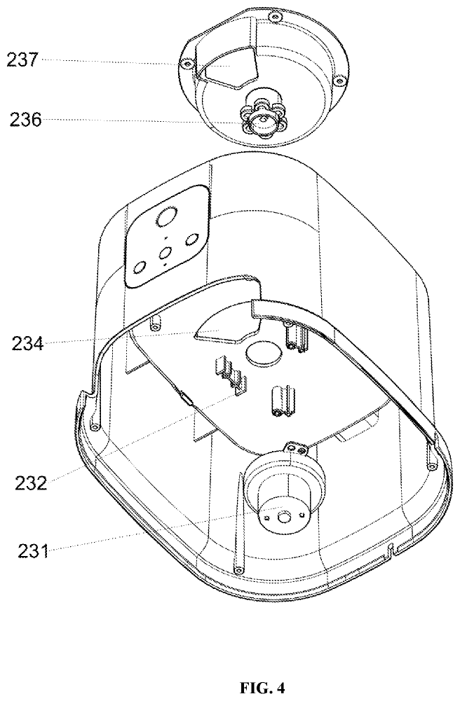

### DETAILED DESCRIPTION OF THE EXEMPLARY EMBODIMENTS

The following further describes the present invention in detail with reference to the accompanying drawings.

This specific embodiment is merely for illustration of the present invention, but not intended to limit the present invention. After reading this specification, a person skilled in the art can make modifications without creative contribution to this embodiment as desired, but such modifications shall all be protected by Patent Law without departing from the scope of the claims of the present invention.

### Embodiments

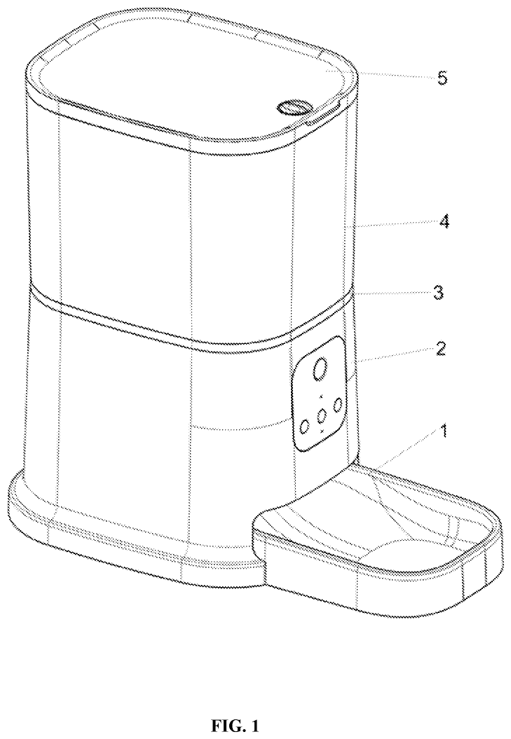

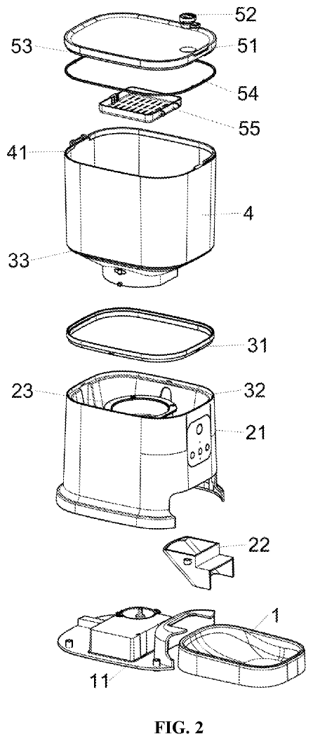

This embodiment relates to a vacuum fresh-keeping feeder with a replaceable food bucket. As shown in FIG. 1 and FIG. 2, the feeder includes: a discharge assembly 2, an accommodating bucket 4, a vacuum apparatus 55, and a connector 3.

The discharge assembly 2 is connected to the accommodating bucket 4. When the discharge assembly 2 works, the discharge assembly 2 discharges the pet food in the accommodating bucket 4 out of the accommodating bucket 4. When the discharge assembly 2 stops working, the accommodating bucket 4 is kept in a sealed state. The vacuum apparatus 55 is disposed on the accommodating bucket 4, and the vacuum apparatus 55 is configured to draw air in the accommodating bucket 4 when the discharge assembly 2 stops working, so that the accommodating bucket 4 keeps a nearly vacuum state inside, and a fresh-keeping and dehumidifying capacity of the accommodating bucket 4 is improved. The connector 3 is disposed between the discharge assembly 2 and the accommodating bucket 4, so that the discharge assembly 2 and the accommodating bucket 4 are detachably assembled. In this embodiment, the vacuum apparatus 55 is a dry vacuum pump. A food leaking opening is provided at the bottom of the accommodating bucket. An electric door is disposed between the accommodating bucket 4 and the discharge assembly 2. The electric door shields the food leaking opening of the accommodating bucket 4 when the discharge assembly 2 stops working, so as to cooperate with the vacuum apparatus 2 to vacuumize the accommodating bucket 4 when the vacuum apparatus 2 works.

Preferably, the connector 3 includes: a clamping ring 31, a first clamping part 32, and a second clamping part 33. The clamping ring 31 is provided with the plurality of clamping blocks, the first clamping part 32 is disposed on a side of the discharge assembly 2 close to the clamping ring 31, the first clamping part 32 and the clamping blocks are detachably assembled, and the second clamping part 33 is disposed on the accommodating bucket 4 and detachably assembled with the clamping blocks on the other side of the clamping ring 31, so that the accommodating bucket 4 can be detached to facilitate cleaning or replacement. When this apparatus is not used for a long time, the accommodating bucket 4 can be detached and cleaned, and the accommodating bucket 4 can serve as a food storage bucket to store the pet food after being detached, to implement multiple functions. In this embodiment, an upper cover 5 is connected to the accommodating bucket 4 in a clamshell manner. Clamping slots 41 are provided in the accommodating bucket 4. Clamping pieces 53 matched with the clamping slots 41 are disposed on the upper cover 5. A seal ring 54 is disposed at a joint of the upper cover 5 and the accommodating bucket 4, to improve sealing performance of the entire apparatus after the mounting of the cover body 51. A knob switch 52 is further disposed on the upper cover 5, to facilitate opening or closing of the entire cover body 51. An end of the cover body 51 is hinged to the accommodating bucket 4 to improve sealing performance of the accommodating bucket 4. In other embodiments, the accommodating bucket 4 and the discharge assembly 2 are assembled in a threaded manner. The accommodating bucket 4 and the upper cover 5 are assembled in a threaded manner. A handle is disposed on an outer wall of the accommodating bucket 4. The connector 3 is two magnets.

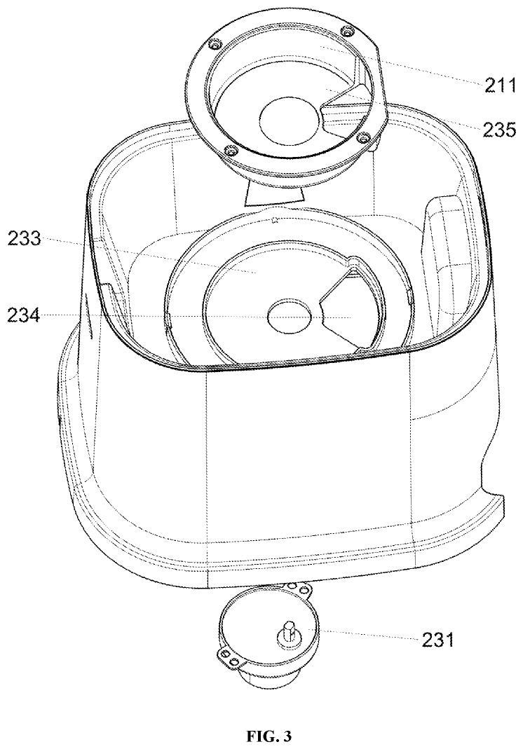

Preferably, as shown in FIG. 2 and FIG. 3, the discharge assembly 2 includes: a food guide base 21 and a discharge member.

The food guide base 21 is disposed at the bottom of the accommodating bucket 4. A discharge frame 211 communicating with the accommodating bucket 4 is disposed on the food guide base 21. The discharge member is disposed in the food guide base 21. The discharge member is configured to control food in the accommodating bucket 4 to fall or stop falling. In this embodiment, the food guide base 21 and the accommodating bucket 4 are detachably assembled, so that this apparatus is convenient to detach, clean, and replace. A base is disposed at the bottom of the food guide base 21. The base 11 is configured to support the entire apparatus. A food guide plate 22 is disposed on a side face of the food guide base 21. The food guide plate 22 is inclined, with a higher end disposed below a discharge position of the discharge assembly 2. A food dish 1 is disposed on the food guide base 21 in an oblique direction, and the food dish 1 is concave inward and configured to accommodate the pet food. A lower end of the food guide plate 22 faces toward the food dish 1. The pet food slides into the food dish 1 by using the food guide base 21 and is prevented from easily falling out of the food dish 1.

Preferably, the discharge member includes: a partition plate 233, a motor 231, and a rotation plate 235.

The partition plate 233 is fixedly disposed in the discharge frame 211. The partition plate 233 is fixedly disposed in the food guide base 21. A first food leaking hole 234 and a through-hole are provided in the partition plate 233 and fixedly provided at the bottom of the partition plate 233. An output shaft of the motor 231 penetrates through the through-hole. one side of the rotation plate 235 is fixedly disposed at an end of the discharge frame 211 away from the accommodating bucket 4, and the other side of the rotation plate 235 is closely attached to the partition plate 233. The rotation plate 235 is connected to the output shaft of the motor 231. A second food leaking hole 237 that corresponds to the first food leaking hole 234 is provided in the rotation plate 235. An annular groove is provided in an outer edge of the partition plate 233. The rotation plate 235 is rotationally disposed in the annular groove. A diameter of the rotation plate 235 is greater than or equal to a diameter of the discharge frame 211 and less than a diameter of the annular groove. When the diameter of the rotation plate 235 is greater than the diameter of the discharge frame 211 and less than the diameter of the annular groove and the motor 231 rotates, the output shaft drives the rotation plate 235 to rotate in the annular groove. When the second food leaking hole 237 of the rotation plate 235 overlaps the first food leaking hole 234 of the partition plate 233, the pet food falls out of the accommodating bucket 4. When the motor 231 continues to rotate, the second food leaking hole 237 and the first food leaking hole 234 are staggered, so that the pet food stops falling. In this embodiment, a mounting sleeve 236 is provided on the rotation plate 235, and the output shaft of the motor 231 and the mounting sleeve 236 on the rotation plate 235 are assembled in a clamped manner, so that the motor 231 and the rotation plate 235 are convenient to detach. A fastening rod 232 for fastening the motor 231 is disposed at the bottom of the partition plate 233.

The working principle of the present invention is generally described as follows. The discharge assembly 2 is connected to the accommodating bucket 4. When the discharge assembly 2 works, the discharge assembly 2 discharges the pet food in the accommodating bucket 4 out of the accommodating bucket 4. When the discharge assembly 2 stops working, the accommodating bucket 4 is kept in a sealed state. The vacuum apparatus 55 is disposed on the accommodating bucket 4, and the vacuum apparatus 55 is configured to draw air in the accommodating bucket 4 when the discharge assembly 2 stops working, so that the accommodating bucket 4 keeps a nearly vacuum state inside, and a fresh-keeping and dehumidifying capacity of the accommodating bucket 4 is improved. The connector 3 is disposed between the discharge assembly 2 and the accommodating bucket 4, so that the discharge assembly 2 and the accommodating bucket 4 are detachably assembled. With such an arrangement, the vacuum fresh-keeping feeder with a replaceable food bucket effectively resolves the defects that an existing pet feeder can only keep the pet food fresh by using a desiccant or a seal ring 54 in use, so that a fresh-keeping effect is poor, and it is troublesome to keep freshness. The vacuum fresh-keeping feeder with a replaceable food bucket has the advantage that pet food in the feeder is kept fresh by vacuum treatment, so that the pet food can be stored for a longer time.

The foregoing is merely used to describe the technical solutions of the present invention but does not constitute any limitation. Other modifications or equivalent replacements made to the technical solutions of the present invention by a person of ordinary skill in the art shall all fall within the scope of the claims of the present invention without departing from the spirits and scope of the technical solutions of the present invention.

What is claimed is:

1. A vacuum fresh-keeping feeder with a replaceable food bucket, comprising:
an accommodating bucket (4);
a discharge assembly (2), wherein the discharge assembly (2) is connected to the accommodating bucket (4), and when the discharge assembly (2) stops working, the accommodating bucket (4) is kept in a sealed state; and
a vacuum apparatus (55), wherein the vacuum apparatus (55) is disposed on the accommodating bucket (4), and the vacuum apparatus (55) is configured to draw air in the accommodating bucket (4).

2. The vacuum fresh-keeping feeder with a replaceable food bucket according to claim 1, wherein a connector (3) is disposed between the discharge assembly (2) and the accommodating bucket (4).

3. The vacuum fresh-keeping feeder with a replaceable food bucket according to claim 2, wherein the connector (3) comprises:
a clamping ring (31), wherein the clamping ring (31) is provided with a plurality of clamping blocks;
a first clamping part (32), wherein the first clamping part (32) is disposed on a side of the discharge assembly (2) close to the clamping ring (31), and the first clamping part (32) and the clamping blocks are detachably assembled; and
a second clamping part (33), wherein the second clamping part (33) is disposed on the accommodating bucket (4) and detachably assembled with the clamping blocks on the other side of the clamping ring.

4. The vacuum fresh-keeping feeder with a replaceable food bucket according to claim 1, wherein the vacuum apparatus (55) is a dry vacuum pump.

5. The vacuum fresh-keeping feeder with a replaceable food bucket according to claim 1, wherein the discharge assembly (2) comprises:
a food guide base (21), wherein the food guide base (21) is disposed at the bottom of the accommodating bucket (4); and
a discharge member, wherein the discharge member is disposed in the food guide base (21), a discharge frame (211) communicating with the accommodating bucket (4) is disposed on the discharge member, and the discharge member is configured to control food in the accommodating bucket (4) to fall or stop falling.

6. The vacuum fresh-keeping feeder with a replaceable food bucket according to claim 5, wherein the discharge member comprises:
a partition plate (233), wherein the partition plate is fixedly disposed in the food guide base (21), and a first food leaking hole (234) and a through-hole are provided in the partition plate (233);
a motor (231) fixedly disposed at the bottom of the partition plate (233), wherein an output shaft of the motor (231) penetrates through the through-hole; and
a rotation plate (235), wherein one side of the rotation plate (235) is fixedly disposed at an end of the discharge frame (211) away from the accommodating bucket (4), the other side of the rotation plate (235) is closely attached to the partition plate (233), the rotation plate (235) is connected to the output shaft of the motor (231), a second food leaking hole (237) that corresponds to the first food leaking hole (234) is provided in the rotation plate (235), an annular groove is provided in an outer edge of the partition plate (233), the rotation plate (235) is rotationally disposed in the annular groove, and a diameter of the rotation plate (235) is greater than or equal to a diameter of the discharge frame (211) and less than a diameter of the annular groove.

7. The vacuum fresh-keeping feeder with a replaceable food bucket according to claim 6, wherein the output shaft of the motor (231) and the rotation plate (235) are detachably assembled.

8. The vacuum fresh-keeping feeder with a replaceable food bucket according to claim 1, wherein an upper cover (5) is disposed on the accommodating bucket (4).

9. The vacuum fresh-keeping feeder with a replaceable food bucket according to claim 8, wherein a seal ring (54) is disposed at a joint of the upper cover (5) and the accommodating bucket (4).

10. The vacuum fresh-keeping feeder with a replaceable food bucket according to claim 1, wherein a food dish (1) is disposed at the bottom of the discharge assembly (2).
